(19) United States
(12) Patent Application Publication
(10) Pub. No.: US 2012/0269953 A1
(43) Pub. Date: Oct. 25, 2012

(54) HIGH PRESSURE PASTEURIZING OF FROZEN GROUND MEATS

(75) Inventors: Jay David Parker, Lubbock, TX (US); Brock Aaron Zentz, Andover, KS (US)

(73) Assignee: CARGILL, INCORPORATED, Wayzata, MN (US)

(21) Appl. No.: 13/497,876

(22) PCT Filed: Sep. 24, 2010
(86) PCT No.: PCT/US10/50221

§ 371 Date: Mar. 23, 2012

Related U.S. Application Data
(60) Provisional application No. 61/245,961, filed on Sep. 25, 2009.

(51) Int. Cl. A23B 4/06; A23L 1/317; A23L 1/314

(52) U.S. Cl. 426/646; 426/393

(57) ABSTRACT

A process for preserving frozen ground meat comprises the steps of a) packaging frozen ground meat in a sealed package; b) placing the packaged frozen ground meat in a pressurization vessel and closing the vessel; c) pressurizing the pressurization vessel containing the packaged frozen ground meat to an elevated pressure of at least about 50,000 psi pressure so the packaged frozen ground meat is placed under the elevated pressure; d) maintaining the elevated pressure on the packaged frozen ground meat for a time of from about 1 to about 300 seconds and at a temperature of from about −50° to about 45° F.; e) then reducing the pressure on the packaged frozen ground meat to ambient pressure; and f) removing the packaged frozen ground meat from the pressurization vessel. Pathogens are effectively killed using this process, providing manufacturing efficiencies and longer product shelf life as compared to other ground meat handling procedures.

### FIELD

The present invention relates to preservation of frozen ground meats. In particular, the present invention relates to preservation of frozen ground meat by application of high pressure.

### BACKGROUND OF THE INVENTION

Ground meat products are distributed either fresh or frozen. The advantage of using frozen meat products is a significantly longer shelf life compared to fresh meat products (typically 120-365 days versus 25 days or less). Therefore inventory risk (shortages and being long on inventory) is a lesser concern of fresh distribution.

A risk associated with frozen ground meats is the potential contamination by pathogens such as E. coli or Salmonella.

According to U.S. Pat. No. 6,033,701, the use of pressure for sterilization of food was discovered early in the 20^{th} century. Early reports of the use of pressure in sterilization focused on fruits. High pressure has been used for treatment of certain foods, such as fish meat and/or kneaded fish meat products as discussed in U.S. Pat. No. 6,440,484 or raw food products, such as raw shellfish as described in U.S. Pat. No. 6,537,601.

U.S. Pat. Nos. 5,593,714 and 6,033,701 describe food product treatment processes where the food product is treated at a pressure of 25,000 psi and a temperature of 18-23 degrees C. for a time period of at least 5 days, or to at least 70 MPa pressure so that said foodstuff or said feedstuff is place under said pressure, maintaining said pressure on said container and said foodstuff or said feedstuff for more than 12 hours at a temperature of between 18 and 23 degrees C., respectively. The very long retention time of these products under pressure as required in these patents is undesirable for mass production purposes.

Companies such as the American Pasteurization Company and Avure Technologies use or provide equipment to carry out High Pressure Processing (HPP) or both. These companies are careful to note that they are not food companies, but are equipment suppliers to food producers. Avure Technologies has been granted a number of patents, all focusing on the equipment and the processes for use of the equipment. The American Pasteurization Company currently lists foods that can be processed using HPP as:
Ready-to-eat meat products
Soups & stews
Various fruits & vegetables
Oysters and shellfish
Jams & jellies
Sauces & dips
Cheeses
   http://www.amerpastco.com/faq.html

Clearly, HPP is not universally useful for treatment of food products, and process parameters have been developed that are product specific.

In 2001, the US FDA Center for Food Safety and Applied Nutrition published an Evaluation and Definition of Potentially Hazardous Foods that among other strategies discussed the use of HPP for Microbial Inactivation. The report stated:

Ground beef can be pasteurized by HPP to eliminate E. coli 0157:H7, Listeria spp., Salmonella spp., or Staphylococcus spp. Much more work is required to develop a suggested hold time at 580 MPa due to the potential for tailing. Changes in product color and appearance may limit the usefulness of HPP treatment pressures above 200 to 300 MPa.

http://www.cfsan.fda.gov/˜comm/ift4-5.html

Further study of use of HPP in inactivation of various microflora in inoculated ground beef has been carried out since the FDA report. For example, an article entitled “High Pressure Inactivation of Citrobacter freundii, Pseudomonas fluorescens and Listeria innocua in Inoculated Minced Beef Muscle” by A. Carlez et al.; Lebensm.-Wiss.u.-Technol., 26, pp. 357-363 (1993) describes pressure treatment of minced beef under a range of pressures for 20 minute periods at various temperatures. This article notes that the greatest reduction in microorganisms was observed at 50° C. Similarly, an article entitled “High-pressure destruction kinetics of Clostridium sporogenes spores in ground beef at elevated temperatures” by Songming Zhu et al.; International Journal of Food Microbiology, 126 (2008) pp. 86-92, combined high pressure treatment with heat, 80-100° C., to provide effective destruction of spores.

The preservation of vegetables in contact with a noble gas, a mixture of noble gases or a mixture containing at least one noble gas is described in U.S. Pat. No. 6,342,261.

### SUMMARY OF THE INVENTION

In the present process, frozen ground meat is packaged in a sealed package. In an embodiment of the invention, fresh ground meat is frozen and then packaged in a sealed package. In another embodiment, fresh ground meat is packaged in a sealed package and then frozen. This package of frozen ground meat is placed in a pressurization vessel, which is pressurized to at least about 50,000 psi pressure, so the packaged frozen ground meat is placed under elevated pressure. This elevated pressure is maintained for a time of from about 1 to about 300 seconds. Preferably, the packaged frozen ground meat is at a temperature of from about −50° to about 45° F. during the pressurization process. The pressure on the packaged frozen ground meat is then reduced to ambient pressure and the packaged frozen ground meat is removed from the pressurization vessel.

The present invention provides an advantage in preservation of ground meat products by efficiently killing or otherwise deactivating or rendering harmless pathogens in the meat and decreasing the risk of pathogen contamination of food eaten by the consumer. In another aspect, spoilage organisms often introduce off odors and flavors in meat even before the meat is unhealthy for consumption. The present invention can improve the length of time that a meat product is at high quality as compared to prior art processes. By use of high pressure, ground meat can advantageously be treated without the use of chemical treatments or incorporation of preservatives that some consumers may find objectionable. In an embodiment of the present invention, ground meat products can be prepared using less than half of the amount of preservatives (such as lactates or salt) as compared to like ground meat products that have not been processed using pressure as described herein. In an embodiment of the present invention, the frozen ground meat additionally contains non-endogenous antimicrobial treatment chemicals to further decrease the risk of pathogen contamination of food eaten by the consumer. In an embodiment of the present invention, the frozen ground meat is free of non-endogenous antimicrobial treatment chemicals. In another embodiment of the present invention, the frozen ground meat is free of stabilizers, preservatives and similar processing aids.

Surprisingly, the pressure used in the present process under the conditions of treatment has been found to be effective in killing pathogens in the meat in a very short period of time, enabling this process to be used in production scale settings. Because the pathogen killing step can be carried out in a time of less than about 300 seconds, preferably less than about 150 seconds, and more preferably less than about 90 seconds, large scale production facilities can use the present process without undue delay in production. This is advantageous because meat producers can immediately respond to product shortages by quickly providing healthy ground meat product that has been treated for pathogens without time-consuming product treatment steps.

Additionally, the present process is surprisingly effective even though the meat is frozen. Thus, pathogens can be effectively killed in ground meat while at the same time maintaining preferred processing conditions whereby the ground meat never exceeds the temperature of 45° F. This allows meat producers to establish an HACCP program using well recognized safe temperature handling protocols without the need to heat the meat. The present invention thus provides a process whereby meat can be processed without transitioning the meat through undesirable temperature ranges (i.e. above conventional refrigeration temperatures and below cooking temperatures).

It has surprisingly been found that frozen ground meat processed in the manner of the present invention can exhibit a significant reduction in pathogen risk by reducing E. coli 0157:H7 by at least 4 log and preferably 5 log.

The above advantages as recognized in the treatment of frozen ground meat are similarly apparent in the treatment of fresh ground meat.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

The meat to be treated in accordance with the present invention may be any variety of meat from any species. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. Preferably the meat is bovine meat, and most preferably beef.

The meat is ground in a conventional manner. In most large scale processing systems, the meat is first ground to ½ inch diameter portions, and the fat content of the meat is adjusted to meet product requirements. The meat then typically is ground again to provide ⅛ to 3/32 “noodles.”

For purposes of discussion, the following description will focus on the exemplary embodiment wherein the meat to be treated is frozen. Distinct process and storage benefits can be in this embodiment. The ability to provide ground meat that has a reduced amount of, or that is free of non-endogenous antimicrobial treatment chemicals is a distinct advantage in the frozen ground meat product. Similarly, the ability to provide frozen ground meat that has a reduced amount of, or that is free of stabilizers, preservatives and similar processing aids is a distinct advantage.

In an embodiment of the present invention, the frozen ground meat contains additional food inclusions. For example, the food inclusions may be selected from mushrooms, onions, garlic, cheeses and combinations thereof. In another embodiment, the ground meat contains seasoning inclusions. This is particularly advantageous because such a combination product provides consumers with the convenience they demand. Further, it is exceptionally difficult to provide combination products on a large commercial scale because spoilage is accelerated when such products are stored in combination.

The ground meat may be frozen either before or after packaging. If the meat is frozen after packaging, the meat is divided into appropriate portions and packaged in a sealed package. In an embodiment of the invention, the packaged frozen ground meat is in a meat portion (i.e. total amount of meat in the package) of from about ⅛ to about 25 pounds of meat, and in another embodiment in a meat portion of from about ⅛ to about 5 pounds of meat. Thus, the meat may be sized for use by institutional customers (e.g. restaurant, food service, or commercial users) or for the home consumer. The meat may be provided in any format, such as in the form of patties, pre-formed meat loaves, stuffed food products such as stuffed peppers, and the like. The packaged meat product is then frozen using commonly accepted methods, such as a mechanical freezing tunnel, conventional blast freezer, liquid immersion, a nitrogen tunnel, or other traditional freezing methods.

The package is an air-tight package suitable for storage, transport and presentation to the consumer. The packaging may be of a bulk, shipping, or individual serving type; wherein the container is a formable pouch, injectable pouch, sealable pouch, formable tray, vacuum formable tray or pouch, heat formable tray or pouch, or film covered tray. In an embodiment, the sealed package comprises a tray and has headspace over the fresh ground meat. Preferably, the frozen ground meat is packaged in a sealed package having an oxygen displaced gas environment, meaning that the amount of oxygen is at least less than present in the common atmosphere, and preferably substantially less than is present in the common atmosphere. Reduction in the exposure of the ground meat to oxygen is advantageous, because this reduces oxidation of the meat. Preferably the gas environment within the meat packaging is purged of oxygen. In an embodiment, the gas environment comprises a gas selected from carbon dioxide, nitrogen, carbon monoxide, nitrous oxide, hydrogen, neon, argon, krypton, xenon and mixtures thereof.

In another embodiment, the meat is divided into appropriate portions and then frozen. The same methods may be used to freeze the packaged ground meat product. For example, ground meat patties may be frozen using a mechanical freezing tunnel. In that case, the patty is typically exposed to high velocity fans which circulate refrigerated air at, for example, −40° F., for a period of time, for example, three to seven minutes.

Ground meat is preferably subjected to a gaseous atmosphere as discussed above by flushing, injecting, sparging, applying a vacuum and then flushing, pressurizing, or introducing said gaseous atmosphere into an impermeable or semipermeable film covering the ground meat.

The packaged frozen ground meat may then be placed in a pressurization vessel and pressure may be applied in any appropriate manner. Equipment used to treat materials using high pressure is described, for example, in U.S. Pat. Nos. 7,220,381; 5,316,745; 5,370,043; 7,310,990; and 7,096,774.

A preferred process comprises submerging the packaged frozen ground meat in a liquid within an enclosed vessel. Pressure is then generated either by pumping more liquid into the pressure vessel or by reducing the volume of the pressure chamber. This pressure is uniformly distributed over all materials in the vessel, and even packages with headspace do not ordinarily burst. The pressurization vessel containing the packaged frozen ground meat is pressurized to an elevated pressure of at least about 50,000 psi. Preferably, the elevated pressure is from about 50,000 psi to about 130,500 psi, more preferably from about 60,000 psi to about 115,000 psi, and even more preferably from about 85,000 psi to about 100,000 psi. The packaged ground meat is treated under elevated pressure for a time of from about 1 to about 300 seconds, more preferably for a time of from about 30 to about 150 seconds, and even more preferably for a time of from about 45 to about 70 seconds.

The pressurization is carried out at a temperature of from about −50° F. to about 45° F. when the ground meat is frozen. Preferably, the temperature of the fresh ground meat is never above 30° F., and more preferably never above about 20° F. during the entire production process from the grinding step through to removal of the ground meat from the pressurization vessel.

Because the frozen ground meat product is already in a sealed package before treatment, the meat is not touched again or exposed to the air or any potentially unsanitary conditions until the package is opened by the consumer.

In a preferred embodiment of the present invention, the packaged frozen ground meat is submerged in liquid during the pressure treatment step. If the packaging is faulty, the present pressure treatment advantageously exposes any packaging defects such as pinholes, usually by permitting a detectable amount of liquid to enter into the package. Thus the present invention beneficially operates to reveal defective packaging that would lead to premature product spoilage if not detected.

In use, the packaged frozen ground meat is sold in distribution channels in the packages in which the meat was treated, ready for customer purchase. This provides significant advantages, in that the package remains sealed until the ultimate customer (e.g. restaurant, food service or home consumer) opens the package and uses the ground meat for the desired purpose.

All patents, patent applications (including provisional applications), and publications cited herein are fully incorporated by reference herein for all purposes as if individually incorporated. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

What is claimed is:

1. A process for preserving frozen ground meat comprising the steps of:
a) packaging frozen ground meat in a sealed package;
b) placing the packaged frozen ground meat in a pressurization vessel and closing the vessel;
c) pressurizing the pressurization vessel containing the packaged frozen ground meat to an elevated pressure of at least about 50,000 psi pressure so that the packaged frozen ground meat is placed under the elevated pressure;
d) maintaining the elevated pressure on the packaged frozen ground meat for a time of from about 1 to about 300 seconds and at a temperature of from about −50° to about 45° F.;
e) then reducing the pressure on the packaged frozen ground meat to ambient pressure; and
f) removing the packaged frozen ground meat from the pressurization vessel.

2. The process of claim 1, wherein the meat is frozen before the meat has been packaged.

3. The process of claim 1, wherein the meat is frozen after the meat has been packaged.

4. (canceled)

5. (canceled)

6. The process of claim 1, wherein the elevated pressure is from about 85,000 psi to about 100,000 psi.

7. The process of claim 1, wherein the packaged frozen ground meat is under elevated pressure for a time of from about 30 to about 150 seconds.

8. The process of claim 1, wherein the packaged frozen ground meat is under elevated pressure for a time of from about 45 to about 70 seconds.

9. The process of claim 1, wherein the sealed package comprises a tray and has headspace over the frozen ground meat.

10. The process of claim 1, wherein the frozen ground meat is packaged in a sealed package having an oxygen displaced gas environment.

11. The process of claim 1, wherein the gas environment comprises a gas selected from carbon dioxide, carbon monoxide, nitrogen, nitrous oxide, hydrogen, neon, argon, krypton, xenon and mixtures thereof.

12. The process of claim 1, wherein the frozen ground meat comprises ground beef.

13. The process of claim 1, wherein the packaged frozen ground meat is in a meat portion of from about ⅛ to about 25 pounds of meat.

14. The process of claim 1, wherein the packaged frozen ground meat is in a meat portion of from about ⅛ to about 5 pounds of meat.

15. The process of claim 1, wherein the frozen ground meat is in the form of patties.

16. The process of claim 1, wherein the frozen ground meat contains additional food inclusions.

17. The process of claim 16, wherein the food inclusions are selected from mushrooms, onions, garlic, cheeses and combinations thereof.

18. The process of claim 1, wherein the frozen ground meat contains seasoning inclusions.

19. The process of claim 1, wherein the frozen ground meat is free of non-endogenous antimicrobial treatment chemicals.

20. A frozen ground meat product prepared by a process comprising the steps of:
a) packaging frozen ground meat in a sealed package;
b) placing the packaged frozen ground meat in a pressurization vessel and closing the vessel;
c) pressurizing the pressurization vessel containing the packaged frozen ground meat to an elevated pressure of at least about 50,000 psi pressure so that the packaged frozen ground meat is placed under the elevated pressure;
d) maintaining the elevated pressure on the packaged frozen ground meat for a time of from about 1 to about 300 seconds and at a temperature of from about −50° to about 45° F.;
e) then reducing the pressure on the packaged frozen ground meat to ambient pressure; and
f) removing the packaged frozen ground meat from the pressurization vessel.
